(19) United States
(12) Patent Application Publication
(10) Pub. No.: US 2026/0305825 A1
(43) Pub. Date: Oct. 8, 2026

(54) MOUNTING BRACKET

(71) Applicant: Xinadda (Singapore) Pte. Ltd., Singapore (SG)

(72) Inventors: Hao XU, Singapore (SG); Yongyi XIONG, Singapore (SG)

(73) Assignee: Xinadda (Singapore) Pte. Ltd., Singapore (SG)

(21) Appl. No.: 19/236,598

(22) Filed: Jun. 12, 2025

(30) Foreign Application Priority Data
Apr. 7, 2025 (CN) 202520639843.X

(51) Int. Cl. A47B 97/00; F16M 11/12

(52) U.S. Cl. CPC A47B 97/001; F16M 11/121; F16M 2200/063

(57) ABSTRACT

The present disclosure relates to a mounting bracket, including a wall plate, a mounting member, and a movable assembly. The mounting member is configured for fixedly connecting to a display device. The movable assembly includes a support arm, a panel structure, connecting members, and a connecting piece. The panel structure comprises a connecting side arm, which is defined with a first elongated connecting hole and a first connecting hole below the first elongated connecting hole. The connecting piece is disposed at the connecting side arm, and the other side of the connecting piece is connected to the first elongated connecting hole and the first connecting hole via two of the connecting members, respectively. When the connecting members are located at different positions of the first elongated connecting hole, the panel structure has different pitch tilt angles relative to the wall plate.

### CROSS-REFERENCE TO RELATED APPLICATIONS

This application claims priority under 35 U.S.C. § 119(a) to Chinese Application Patent Application No. 202520639843.X, filed on April 07, 2025, the entire disclosure of which is hereby incorporated by reference.

### TECHNICAL FIELD

The present disclosure relates to technical fields of display device mounting, and in particular relates to a mounting bracket.

### BACKGROUND

With the rapid development of the social-economy and the improvement of living standards, televisions and display screens have generally become larger. However, structures of traditional mounting bracket are often bulky and thick, which not only occupies more space and hinders efficient space utilization but also increases costs and difficulties during transportation and mounting, which is particularly problematic in indoor environments with strict space layout requirements, where thick mounting bracket can make the space feel even more cramped. As a result, existing mounting brackets struggle to meet current demands.

### SUMMARY

The present disclosure provides a mounting bracket to solve at least one problem mentioned in the above background.

To solve the at least one problem mentioned in the above background, the present disclosure provides a mounting bracket. The mounting bracket can include a wall plate, at least one hanging member, and a movable assembly. The at least one hanging member is configured for fixed connection with a display device. The movable assembly can include at least one support arm, a panel structure, at least one connection piece, and at least one pair of connection members. One end of the support arm is pivotally connected to the wall plate. The panel structure can include an upper horizontal arm and a lower horizontal arm parallel to the upper horizontal arm, as well as at least one connection side arm vertically connected between the upper horizontal arm and the lower horizontal arm. Each hanging member is connected to the upper horizontal arm and locked to the lower horizontal arm. A plane of the connection side arms is perpendicular to an extending direction of the upper horizontal arm and the lower horizontal arm. The connection side arm defines a first elongated connection hole and a first connection hole penetrating through the connection side arm. The first elongated connection hole is horizontally arranged and located above the first connection hole. The connection piece is arranged at the connection side arm. One side of the connection piece is pivotally connected to the other end of the support arm, and the other side of the connection piece is connected to the first elongated connection hole and the first connection hole via the pair of the connection members. When the connection piece is fixed at different positions in the first elongated connection hole, the panel structure has different pitch angles relative to the wall plate.

In the above mounting bracket, by cooperating the connection piece with the first elongated connection hole and the first connection hole on the connection side arm, the position of the connection piece at the first elongated connection hole can be adjusted, thereby changing the pitch angle of the panel structure relative to the wall plate. One end of the support arm is pivotally connected to the wall plate and the other end of the support arm is pivotally connected to the connection piece, by cooperating the at least one hanging member connected to the upper horizontal arm and fixed to the lower horizontal arm, ensuring the stability and reliability of the mounting bracket and guaranteeing safety during use. Moreover, the mounting bracket adopts an ultra-thin structural design, significantly reducing a space occupied by the mounting bracket itself. During mounting, the mounting bracket can better adapt to environments with limited space, improving space utilization. The ultra-thin structure also makes transportation more convenient.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skill in the art may also obtain other drawings based on these drawings without any creative efforts.

FIG. 1a is an overall structural view of a mounting bracket according to at least one embodiment of the present disclosure.

FIG. 1b is a schematic structural view of the connection piece and connection members of the mounting bracket shown in FIG. 1a from first view.

FIG. 2a is a schematic structural view of the connection piece and connection members of the mounting bracket shown in FIG. 1a from second view.

FIG. 2b is a schematic structural view of the connection member of the mounting bracket shown in FIG. 2a.

FIG. 3 is an exploded structural view of the support arm of the mounting bracket shown in FIG. 1a.

FIG. 4a is a schematic structural view of the hanging member of the mounting bracket shown in FIG. 1a.

FIG. 4b is an enlarged view of FIG. 4a taken along a circle A.

FIG. 4c is an enlarged view of FIG. 4a taken along a circle B.

FIG. 5a is a structural view of the mounting bracket in a folded state as shown in FIG. 1a.

FIG. 5b is a schematic structural view of the anti-rebound structure shown in FIG. 5a.

FIG. 6a is an exploded view of a ball plunger of the anti-rebound structure.

FIG. 6b is an exploded view of a snap-fit member of the anti-rebound structure.

FIG. 7a is a structural view of the wall plate of the mounting bracket shown in FIG. 1a.

FIG. 7b is an enlarged view of FIG. 7a taken along a circle C.

FIG. 8 is a front view of the mounting bracket in the folded state shown in FIG. 1a.

The reference numerals in the detailed description are as follows:

Mounting bracket 100; Wall plate 110; Upper horizontal plate 110a; Lower horizontal plate 110b; Side plate 111; Connecting assembly 112; End connecting plate 112a; Positioning plate 112b; Support arm 120; Rear support arm 121; Front support arm 122; Panel structure 130; Upper horizontal arm 131a; Lower horizontal arm 131b; Connection side arm 132; Extension plate 133;

Connection piece 140; Main body portion 140a; U-shaped connection portion 140b; Connection member 141; Non-circular segment 141a; Hanging member 150; Hanging strip 151; Movable plate 151a; Movable side plate 151b; Hanging hook 152; Connecting plate 152a; Connecting side plate 152b; First fixing plate 153; Second fixing plate 154;

Anti-rebound structure 160; Snap-fit member 161; groove 161a; Ball plunger member 162; ball plunger 162a; Avoidance structure 170; Movable assembly 180;

First elongated connection hole H1; First connection hole H2; Second connection hole H3; Third connection hole H4; Fourth connection hole H5; Second elongated connection hole H6; Fifth connection hole H7; Sixth connection hole H8; Third elongated connection hole H9; Seventh connection hole H10; Eighth connection hole H11; Ninth connection hole H12; Tenth connection hole H13; First mounting hole H14; Second mounting hole H15; Adjusting screw L1; First connecting screw L2; Long connecting screw L3; Second screw L4; Second connecting screw L5; Third connecting screw L6; First fixing component F1; Spacer F2; Second fixing component F3.

### DETAILED DESCRIPTION OF ILLUSTRATED EMBODIMENTS

Embodiments of the present disclosure are described in detail below. Examples of the embodiments are shown in the accompanying drawings. The same or similar labeling throughout denotes the same or similar elements or elements having the same or similar functions. The embodiments described below by reference to the accompanying drawings are exemplary and are intended to be configured to explain the present disclosure and are not to be construed as limiting the present disclosure.

Furthermore, the terms "first" and "second" are configured for descriptive purposes only and are not to be understood as indicating or implying relative importance or implicitly specifying the number of technical features indicated. Therefore, a feature defined with "first" or "second" may include one or more such features, either explicitly or implicitly. In the description of the present disclosure, "more than one" means two or more, unless otherwise expressly and specifically limited.

In the present disclosure, unless otherwise expressly specified and limited, the terms "connected", "fixed", and so on are to be understood broadly, e.g., they may be fixedly connected, removably connected, or integrally connected; they may be mechanically connected or electrically connected; they may be directly connected or indirectly connected through an intermediate medium; they may be interconnected within two elements or an interactive relationship between two elements. For those of ordinary skill in the art, the specific meaning of the above terms in the present disclosure may be understood on a case-by-case basis.

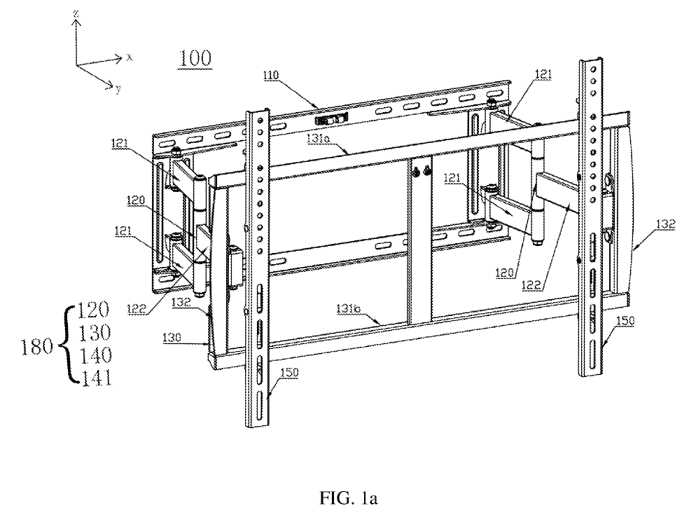

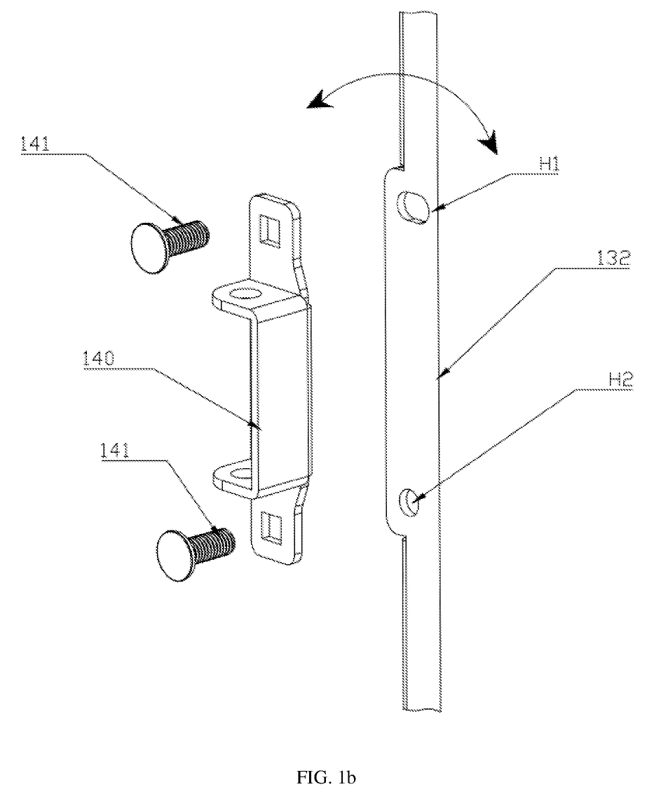

Please refer to FIGS. 1a and 1b, FIG. 1a is an overall structural view of a mounting bracket according to at least one embodiment of the present disclosure. FIG. 1b is a schematic structural view of the connection piece and connection members of the mounting bracket shown in FIG. 1a from first view. As shown in FIG. 1a, the mounting bracket 100 can include a wall plate 110, at least one hanging member 150, and a movable assembly 180. The hanging member 150 is configured for fixed connection with a back of a display device (not shown). The movable assembly 180 can include at least one support arm 120, a panel structure 130, at least one connection piece 140, and at least two pairs of connection members 141. One end of the support arm 120 is pivotally connected to the wall plate 110, and the other end of the support arm 120 is pivotally connected to one side of the connection piece 140. The other side of the connection piece 140 is connected to the panel structure 130 via the pair of connection members 141. Specifically, the panel structure 130 can include an upper horizontal arm 131a and a lower horizontal arm 131b horizontally parallel to each other, as well as at least one connection side arm 132 vertically connected between the upper horizontal arm 131a and the lower horizontal arm 131b. A plane of the connection side arm 132 is perpendicular to an extending direction of the upper horizontal arm 131a and the lower horizontal arm 131b. The connection side arm 132 is defined with a first elongated connection hole H1 and a first connection hole H2 penetrating through the connection side arm 132. The first elongated connection hole H1 is horizontally arranged and located above the first connection hole H2. The other side of the connection piece 140 is connected to the first elongated connection hole H1 and the first connection hole H2 via the pair of the connection members 141. The hanging member 150 is connected to the upper horizontal arm 131a and locked to the lower horizontal arm 131b. When the connection members 141 are fixed at different positions in the first elongated connection hole H1, the panel structure 130 has different pitch angles relative to the wall plate 110.

For ease of description, a front-rear direction of the mounting bracket 100 shown in FIG. 1a is defined as the Y-axis direction (i.e., the thickness direction), a left-right direction shown in FIG. 1a is defined as the X-axis direction (i.e., the length direction), and a height direction shown in FIG. 1a is defined as the Z-axis direction. The directional terms such as "upper," "lower," "left," and "right" used in the description of the mounting bracket 100 in the embodiments of the present disclosure are based on the orientation shown in FIG. 1a of the specification drawings, with the positive Z-axis direction as "upper," the negative Z-axis direction as "lower," the negative X-axis direction as "left," the positive X-axis direction as "right," the negative Y-axis direction as "rear," and the positive Y-axis direction as "front." These terms do not limit the actual application scenarios of the mounting bracket 100.

Therefore, when adjusting the pitch angle of the display device, the connection members 141 are loosened. Due to the horizontal arrangement and length allowance of the first elongated connection hole H1, manual application of external force can change the connection position between the connection piece 140 and the panel structure 130. After adjusting to the desired pitch angle, the connection members 141 are tightened again to fix the panel structure 130 in the corresponding position. Specifically, referring to FIG. 1a, after loosening the connection members 141, since the first elongated connection hole H1 is horizontally arranged (i.e., along the Y-axis direction) with length allowance, manual application of external force causes the panel structure 130 to rotate relative to the connection piece 140 around the X-axis (i.e., the direction of the curved arrow in the FIG. 1b). During this rotation, the angle between the panel structure 130 and the wall plate 110 changes, which reflects the adjustment of the pitch angle. When the desired pitch angle is reached, the connection members 141 are tightened to fix the panel structure 130.

Additionally, unlike conventional designs where the angle adjustment mechanism is placed in the middle, this design locates the pitch angle adjustment mechanism at edge position of the panel structure 130. In practical adjustment processes, due to the pitch angle adjustment mechanism located at edge position of the panel structure 130, the operating space is more ample, allowing users to apply force more easily for angle adjustment.

The display device may include devices such as televisions, monitors, and electronic whiteboards.

In at least one embodiment, the pitch angle adjustment range may be [0, +3°]. The adjustment range of the pitch angle can be set according to actual conditions and is not specifically limited here.

Through the above mounting bracket 100, the needs for different angles of the display device in various scenarios can be met, allowing the display device to be adjusted to the most comfortable viewing angle and the best display angle. Moreover, the pivotal connection of the support arm 120 with the wall plate 110 and the connection piece 140, combined with the connection with the upper horizontal arm 131a and locking of the hanging member 150 with the lower horizontal arms 131b, ensures that the mounting bracket 100 remains stable after angle adjustment and maintains normal mounting of the display device even under external force interference.

Furthermore, the structure of the mounting bracket 100 of the present disclosure is relatively simple, easy to understand and assemble, saves labor and time costs during mounting, and facilitates later maintenance.

In at least one embodiment, the first elongated connection hole H1 is an arc-shaped hole centered on the first connection hole H2. Therefore, the arc-shaped first elongated connection hole H1 allows the connection piece 140 to more precisely control the change of the pitch angle of the panel structure 130 relative to the wall plate 110 during movement. The movement trajectory of the connection piece 140 can more closely follow the circular motion centered on the first connection hole H2, achieving smoother angle adjustment. In terms of structural stability, since the connection piece 140 moves within the arc-shaped hole, the direction of force always revolves around the center of the first connection hole H2, making the connection points between the support arm 120, the connection piece 140, and the connection side arm 132 more evenly stressed. This better disperses the stress generated by angle adjustment, reduces local stress concentration, further enhances the structural stability of the mounting bracket 100 at different pitch angles, lowers the risk of component damage due to uneven stress, and extends the service life of the mounting bracket 100.

The arc-shaped first elongated connection hole H1 also makes the angle adjustment operation smoother. When adjusting the pitch angle of the display device, users can experience linear and continuous adjustment feedback, improving operational convenience and comfort, thereby enhancing the user experience.

In at least one embodiment, the first elongated connection hole H1 may also be a straight elongated hole centered on the first connection hole H2. During adjustment, the connection member 141 can move linearly within the straight elongated hole, thereby controlling the change of the pitch angle of the panel structure 130 relative to the wall plate 110.

In at least one embodiment, the first elongated connection hole H1 may also include polygonal holes, trapezoidal holes, and combined-shape holes centered on the first connection hole H2. The shape of the first elongated connection hole H1 can be set according to actual conditions and is not specifically limited here.

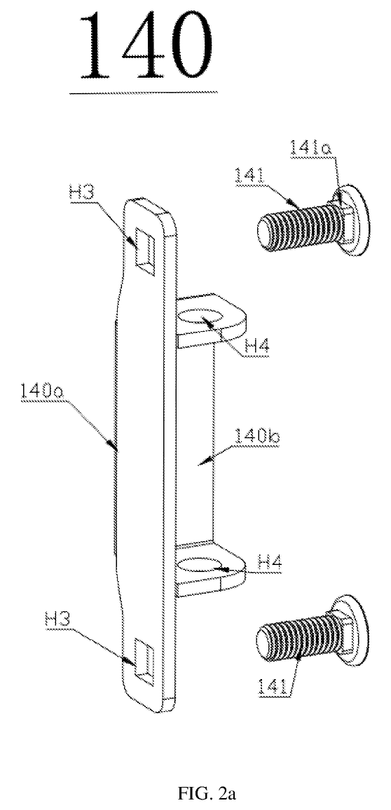

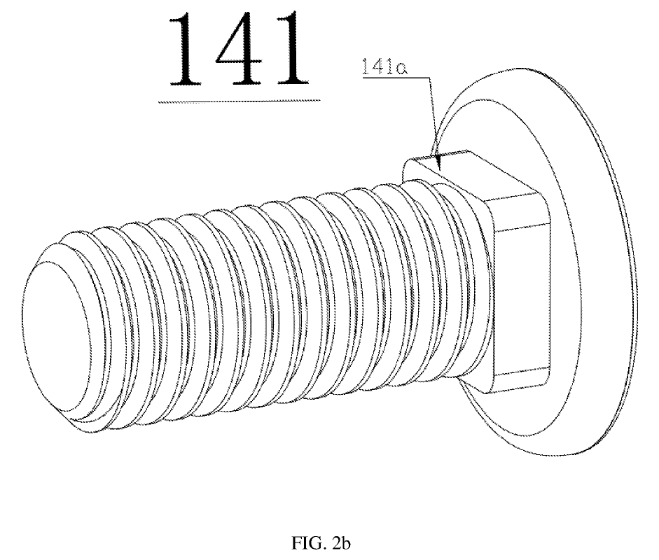

In at least one embodiment, please refer to FIGS. 2a and 2b. FIG. 2a is a schematic structural view of the connection piece and connection members of the mounting bracket shown in FIG. 1a from second view. FIG. 2b is a schematic structural view of the connection member of the mounting bracket shown in FIG. 2a. The connection piece 140 can include a main body portion 140a and a U-shaped connection portion 140b. The main body portion 140a is a long strip-shaped plate structure. The main body portion 140a defines two second connection holes H3 penetrating through the main body portion 140a. The two second connection holes H3 correspond to the first elongated connection hole H1 and the first connection hole H2 on the connection side arm 132, respectively. The U-shaped connection portion 140b is vertically connected on one side of the main body portion 140a away from the connection side arm 132. An opening of the U-shaped connection portion 140b faces the wall plate 110. The U-shaped connection portion 140b is located between the two second connection holes H3 on the main body portion 140a.

A connection between the long strip-shaped structure of the main body portion 140a and the connection side arm 132 provides a large contact area. Through the cooperation of the two second connection holes H3 with the first elongated connection hole H1 and the first connection hole H2 respectively, and then one second connection holes H3 and the first elongated connection hole H1 fixation with one connection member 141, and one second connection holes H3 and the first connection hole H2 fixation with one connection member 141, a stable connection is formed, effectively preventing displacement or loosening of the connection piece 140 during adjustment and ensuring the structural stability of the mounting bracket 100. At the same time, the structure of the U-shaped connection portion 140b further enhances the connection strength between the connection piece 140 and the support arm 120. The two side arms of the U-shaped connection portion 140b can better wrap around the end of the support arm 120, ensuring a stable connection between the connection piece 140 and the support arm 120 and avoiding connection failure due to excessive force.

Please continue to refer to FIGS. 2a and 2b. In one embodiment, the two second connection holes H3 on the main body portion 140a of the connection piece 140 are non-circular holes, and each connection member 141 can include a matching non-circular segment 141a. When the connection member 141 passes through the non-circular hole, the non-circular hole and the non-circular segment 141a of the connection member 141 fit together, restricting the rotation of the connection member 141 relative to the connection piece 140 and forming an anti-rotation structure.

In at least one embodiment, the two second connection holes H3 on the main body portion 140a of the connection piece 140 may include square holes, and the connection members 141 may include matching square segments. An inner diameter of an inscribed circle of the square segment on the connection member 141 is larger than an outer diameter of a threaded rod of the connection member 141.

Therefore, the square hole and the square segment fit together, effectively preventing the connection member 141 from rotating within the connection hole H3, which ensures that the connection between the connection piece 140 and the connection member 141 remains stable during daily use of the mounting bracket 100 and when adjusting the pitch angle of the panel structure 130, avoiding loosening due to rotation of the connection member 141 and ensuring stable mounting of the display device. At the same time, the cooperation between the square hole and square segment provides clear positioning directions during mounting. Operator does not need to repeatedly adjust angles to align the connection holes, improving mounting efficiency and reducing mounting errors.

In at least one embodiment, the two second connection holes H3 on the main body portion 140a of the connection piece 140 may include polygonal holes, and the connection members 141 may include matching polygonal segments. The shape of the anti-rotation structure can be set according to actual conditions and is not specifically limited here.

In at least one embodiment, please continue to refer to FIG. 1a. The support arm 120 can include at least one rear support arm 121 and a front support arm 122. One end of the rear support arm 121 is hinged to the wall plate 110, one end of the front support arm 122 is hinged to the other end of the rear support arm 121, and the other end of the front support arm 122 is pivotally connected to the connection piece 140.

Therefore, the mounting bracket 100 can flexibly adjust the position and angle of the display device, achieving multi-angle and multi-dimensional adjustment of the display device. Users can precisely adjust the position and angle of the display device according to actual usage needs to achieve the best viewing effect.

Specifically, since the rear support arm 121 is hinged to the wall plate 110 and the front support arm 122 is hinged to the rear support arm 121, when the rear support arm 121 and the front support arm 122 rotate, the connection piece 140 and the panel structure 130 connected to the connection piece 140 can move in the X-axis direction, thereby changing the orientation of the display surface of the display device. At the same time, the connection of the support arm 120 allows the display device to move forward and backward in the Y-axis direction, achieving a telescopic effect.

The front support arm 122 is pivotally connected to the connection piece 140, and the connection piece 140 is connected to the panel structure 130 with the first elongated connection hole H1 and the first connection hole H2 via the pair of the connection members 141. By loosening the connection members 141 and utilizing the characteristics of the first elongated connection hole H1, the display device can rotate around the axis of the X-axis to adjust the pitch angle. At the same time, the hinge connection between the rear support arm 121 and the wall plate 110, combined with the hinge connection between the front support arm 122 and the rear support arm 121, allows the display device to rotate left and right around the Z-axis, changing the orientation of the display surface to adapt to different viewing angles.

The multi-segment design of the rear support arm 121 and front support arm 122 effectively distributes the load. The weight of the display device and external forces encountered during use are transmitted from the front support arm 122 to the rear support arm 121 and then dispersed to the wall plate 110, avoiding excessive stress at a single point. This ensures that the mounting bracket 100 remains stable even when supporting heavier display devices. During angle adjustment, the hinge connection between the rear support arm 121 and the wall plate 110 has a pivot axis extending vertically, allowing the rear support arm 121 to rotate left and right around this vertical pivot axis (i.e., rotating around the Z-axis), thereby driving the front support arm 122 connected to the rear support arm 121 and changing the orientation of the display surface. Similarly, the hinge connection between the front support arm 122 and the rear support arm 121 also has a pivot axis extending vertically, further enhancing the flexibility of the mounting bracket 100 during adjustment. The pivotal connection between the front support arm 122 and the connection piece 140 also has a pivot axis extending vertically, allowing the front support arm 122 to perform telescopic movement forward and backward while automatically adapting to the stress generated by angle changes during adjustment of the pitch angle of the display device. This multi-pivot design with vertically extending pivot axes further enhances structural stability, reduces the risk of component damage due to uneven stress, and ensures reliable operation of the mounting bracket 100 under various angle adjustments and load conditions.

In at least one embodiment, please refer to FIGS. 2a and 2b. The two opposite side arms of the U-shaped connection portion 140b are horizontally arranged and each side arm is defined with a third connection hole H4 penetrating along the height direction of the mounting bracket 100. One end of the front support arm 122 is embedded in the U-shaped connection portion 140b, and a first screw passes through the third connection hole H4 to pivotally connect the front support arm 122 and the U-shaped connection portion 140b.

The two opposite side arms of the U-shaped connection portion 140b refer to the two edges of the U-shaped structure that are opposite in the opening direction, i.e., the two edges extending perpendicularly from the main body portion of the U-shaped connection portion 140b in a parallel and symmetrical arrangement. Each side arm is defined with the penetrating third connection hole H4 for passing the first screw or other connection member to achieve a stable connection with other parts, enhancing the overall structural stability.

Therefore, when the mounting bracket 100 bears the weight of the display device and various forces generated during angle adjustment, the connection structure which one end of the front support arm 122 is embedded in the U-shaped connection portion 140b can effectively distribute stress, avoiding excessive stress at a single point that could cause loosening or damage to the connection, and ensuring that the mounting bracket 100 remains stable during long-term use, providing reliable support for the display device. At the same time, the front support arm 122 can flexibly rotate according to the angle adjustment needs of the mounting bracket 100, ensuring stability and accuracy during rotation.

In at least one embodiment, the mounting bracket 100 includes two support arms 120, two connection pieces 140, and two connection side arms 132. The two connection side arms 132 are respectively connected to opposite sides of the panel structure 130. The support arms 120, connection pieces 140, and connection side arms 132 correspond one-to-one. The front support arms 122 of the two support arms 120 are respectively embedded in the U-shaped connection portions 140b of the two connection pieces 140 and pivotally connected. The main body portions 140a of the two connection pieces 140 are respectively connected to the two connection side arms 132.

Therefore, the bilateral symmetrical support structure can evenly distribute the weight of the display device and various external forces encountered during use, effectively avoiding structural tilting or deformation caused by unilateral force and ensuring the overall stability of the mounting bracket 100, significantly enhancing its load-bearing capacity.

Furthermore, the mounting bracket 100 of the present disclosure adopts a single-wall-plate dual-support-arm structure, i.e., a bilateral symmetrical support structure is formed by one wall plate 110 paired with rear support arms 121 and front support arms 122. In practical use, the weight of the display device and various external forces encountered during daily operation are evenly distributed through this bilateral symmetrical support structure. This design effectively avoids structural tilting or deformation caused by unilateral force. At the same time, the single-wall-plate dual-support-arm bilateral symmetrical structure of the mounting bracket 100 allows both support arms 12 to share the acting forces, ensuring the overall structural stability of the mounting bracket 100 and greatly enhancing its load-bearing capacity, enabling it to reliably support various display devices.

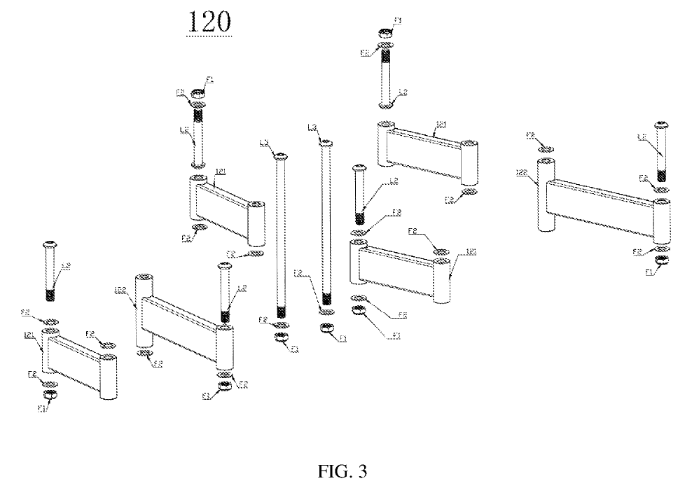

In at least one embodiment, please refer to FIG. 3. FIG. 3 is an exploded structural view of the support arm of the mounting bracket shown in FIG. 1a. The specific mounting process of the support arm 120 is as follows: place spacer F2 in appropriate positions, then sleeve the rear support arm 121 onto the first connecting screw L2, and then sequentially mount spacer F2 and first fixing component F1 at the other end of the first connecting screw L2. Use a tool to tighten the first fixing component F1, ensuring a tight connection between the rear support arm 121 and other parts through the threaded engagement of the first fixing component F1 and the first connecting screw L2, guaranteeing connection stability and reliability. Next, sleeve the front support arm 122 onto the first connecting screw L2, and then sequentially mount spacer F2 and first fixing component F1 at the other end of the first connecting screw L2, and tighten them to achieve a stable connection between the front support arm 122 and the connection piece 140. Finally, pass the long connecting screw L3 through the corresponding holes on the rear support arm 121 and front support arm 122 that need to be connected, and then sequentially mount the spacer F2 and first fixing component F1 at the other end of the long connecting screw L3 and tighten them to firmly connect the rear support arm 121 and front support arm 122 into an integral unit, jointly bearing the load and external forces, ensuring the support arm 12 can stably support the mounting bracket 100 and display device.

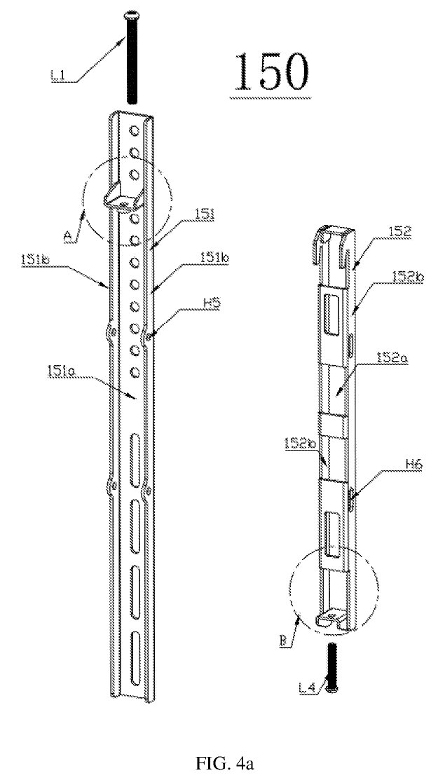

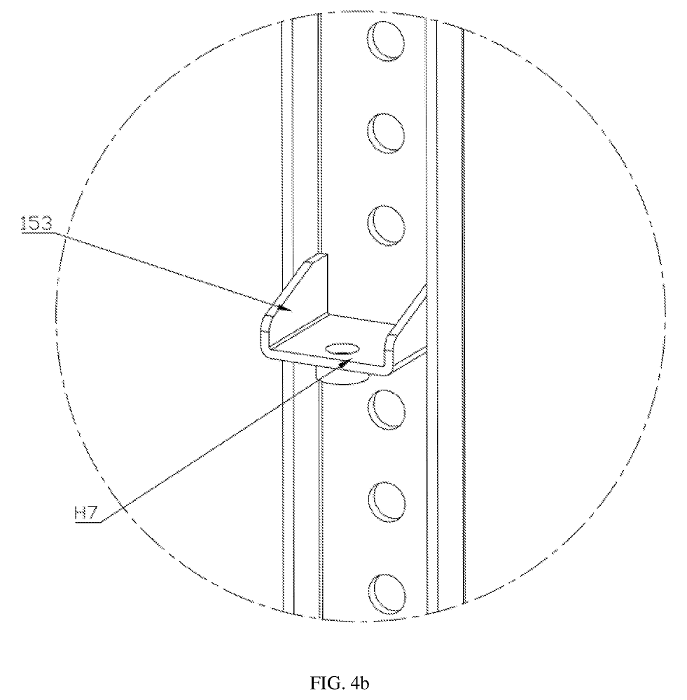

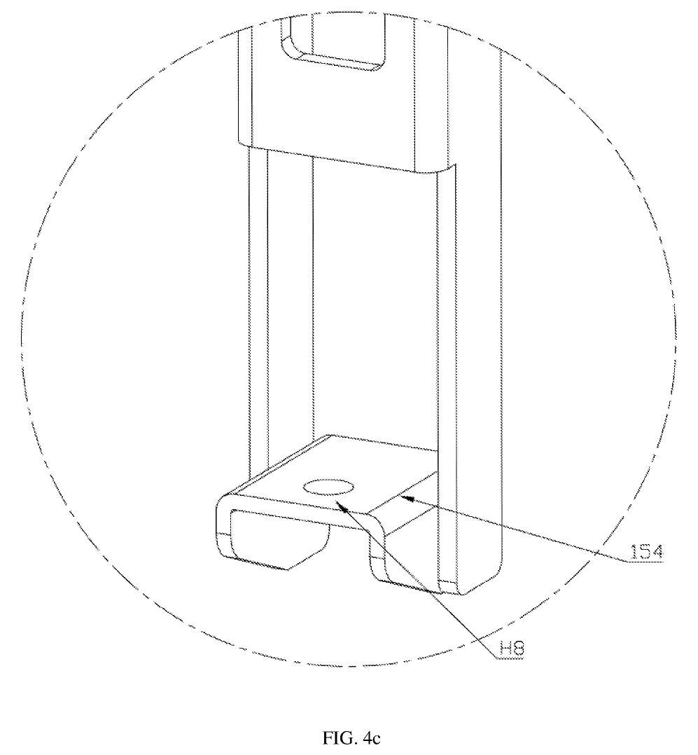

In at least one embodiment, please refer to FIGS. 4a, 4b and 4c. FIG. 4a is a schematic structural view of the hanging member of the mounting bracket shown in FIG. 1a. FIG. 4b is an enlarged view of FIG. 4a taken along a circle A. FIG. 4c is an enlarged view of FIG. 4a taken along a circle B. The mounting bracket 100 can include two hanging members 150. Each hanging member 150 is connected to the back of the display device. Each hanging member 150 can include a hanging strip 151, a hanging hook 152, and an adjusting screw L1. The hanging strip 151 and the hanging hook 152 are connected and have a freedom of movement in the height direction. The hanging hook 152 is connected to the upper horizontal arm 131a of the panel structure 130. The adjusting screw L1 is threaded into the hanging strip 151 and abuts against the upper horizontal arm 131a.

The hanging strip 151 and the hanging hook 152 have the freedom of movement in the height direction. By rotating the adjusting screw L1 and utilizing the threaded connection between the adjusting screw L1 and the hanging strip 151, the hanging strip 151 can be precisely pushed to move relative to the hanging hook 152 in the height direction, further adjusting the horizontal tilt angle of the display device. The horizontal tilt angle refers to the angle formed between an upper plane of the display device and an absolute horizontal reference plane. When the angle is 0°, the display device is perfectly level. If the angle is not 0°, the display device has a tilt relative to the horizontal direction(X-axis direction). By adjusting the hanging strip 151 in the height direction, the height of different parts of the display device can be changed, thereby altering the size of this angle and bringing the display device closer to or achieving a perfectly level state.

The hanging member 150 may include two pieces. The two hanging members 150 both have the above structure. During actual mounting, factors such as wall flatness and mounting accuracy of the wall plate 110 may cause the display device to be insufficiently level. Through the above structure, the operator does not need to make large-scale adjustments to the entire mounting bracket or wall. Simply adjusting the adjusting screw L1 can quickly correct the horizontal tilt angle of the display device, helping to reduce mounting time and improve work efficiency. Specifically, when a horizontal deviation of the display device is detected, the operator only needs to rotate at least one adjusting screw L1 to cause precise displacement of the hanging strip 151 relative to the hanging hook 152 in the height direction. For example, if the left side of the display device is too high, the operator can operate the adjusting screw L1 on the left hanging member 150 to push the hanging strip 151 downward, lowering the left height. Alternatively, the operator can operate the adjusting screw L1 on the right hanging member 150 to raise the hanging strip 151, increasing the right height. If the right side is too high, the adjusting screw L1 on the right hanging member 150 can be operated to lower the right height, quickly adjusting the horizontal tilt angle of the display device. Similarly, the adjusting screw L1 on the left hanging member 150 can be operated to raise the left hanging strip 151, increasing the left height.

In at least one embodiment, the hanging strip 151 can include a movable plate 151a and two movable side plates 151b respectively connected to two opposite sides of the movable plate 151a. The movable plate 151a and the two movable side plates 151b form a clamping space. The hanging hook 152 can include a connecting plate 152a and two connecting side plates 152b respectively connected to two opposite sides of the connecting plate 152a. The size of the hanging hook 152 is smaller than that of the hanging strip 151 and is accommodated in the clamping space of the hanging strip 151. The movable side plate 151b is defined with a plurality of fourth connection holes H5 penetrating through the movable side plate 151b. The connecting side plate 152b is defined with a plurality of second elongated connection holes H6 extending in the height direction. The plurality of second elongated connection holes H6 correspond to the plurality of fourth connection holes H5 respectively. When the adjusting screw L1 is adjusted, the second elongated connection holes H6 allows the hanging strip 151 to move relative to the hanging hook 152 in the height direction, which causes the panel structure 130 to have different tilt angles in the horizontal direction.

The movable side plate 151b of the hanging strip 151 is defined with fourth connection holes H5, and the connecting side plate 152b of the hanging hook 152 is defined with second elongated connection holes H6 extending in the height direction. The fourth connection hole H5 and the second elongated connection holes H6 cooperate with each other.

When the adjusting screw L1 is rotated to move the hanging strip 151 relative to the hanging hook 152 in the height direction, due to the length allowance of the second elongated connection holes H6 in the height direction, the relative position of the hanging strip 151 and the hanging hook 152 can be adjusted, changing the horizontal tilt angle of the display device to meet user needs for the horizontal tilt angle of the display device. At the same time, the hanging hook 152 is accommodated in the clamping space of the hanging strip 151, and the connection between the hanging hook 152 and the hanging strip 151 is achieved through the cooperation of the second elongated connection holes H6 and the fourth connection holes H5. This design ensures the stability of the connection between the hanging strip 151 and the hanging hook 152 while allowing horizontal tilt angle adjustment. When the display device is subjected to external vibrations or other forces, the connection structure between the hanging strip 151 and the hanging hook 152 can effectively distribute stress, preventing loosening of the connection due to uneven force and ensuring that the display device maintains a stable horizontal tilt angle during use, avoiding angle deviation caused by loose connections, and providing strong support for the long-term stable operation of the display device.

In at least one embodiment, please continue to refer to FIGS. 4a and 4b. One end of the hanging strip 151 can include a first fixing plate 153 perpendicular to the hanging strip 151. The first fixing plate 153 is defined with a penetrating fifth connection hole H7. The adjusting screw L1 passes through the fifth connection hole H7 of the first fixing plate 153 and abuts against the upper horizontal arm 131a.

The fifth connection hole H7 on the first fixing plate 153 provides precise positioning and mounting for the adjusting screw L1. Thus, the adjusting screw L1 can easily pass through the fifth connection hole H7 and directly abut against the upper horizontal arm 131a, reducing the mounting difficulty of the adjusting screw L1. At the same time, the first fixing plate 153 enhances the connection stability between the adjusting screw L1 and the hanging strip 151. When the adjusting screw L1 applies force to the hanging strip 151 during rotation, the first fixing plate 153 can effectively distribute this force, avoiding deformation or damage to the hanging strip 151 due to excessive local stress.

Additionally, by adjusting the position of the adjusting screw L1 in the fifth connection hole H7 and its abutment with the upper horizontal arm 131a, the mounting bracket 100 can flexibly adapt to differences in the height and position of the upper horizontal arm 131a, meeting diverse mounting needs.

In at least one embodiment, please continue to refer to FIGS. 4a and 4c. One end of the hanging hook 152 can include a second fixing plate 154 perpendicular to the hanging hook 152. The second fixing plate 154 is defined with a penetrating sixth connection hole H8. The hanging member 150 can further include a second screw L4. The second screw L4 is threaded into the sixth connection hole H8 and abuts against the lower horizontal arm 131b.

Therefore, the hanging strip 151 abuts against the upper horizontal arm 131a through the adjusting screw L1, and the hanging hook 152 abuts against the lower horizontal arm 131b through the second screw L4, forming a dual locking structure at the top and bottom. This makes the connection between the hanging member 150 and the panel structure 130 more stable, effectively resisting shaking and displacement of the display device caused by external forces such as vibrations and collisions during use. At the same time, when the display device is subjected to external forces, the adjusting screw L1 and the second screw L4 can share the acting forces, distributing the force to the upper horizontal arm 131a and the lower horizontal arm 131b, avoiding excessive stress at a single point. This helps extend the service life of the components of the mounting bracket 100, reduces the risk of component damage due to local stress concentration, and improves the overall reliability and durability of the mounting bracket 100.

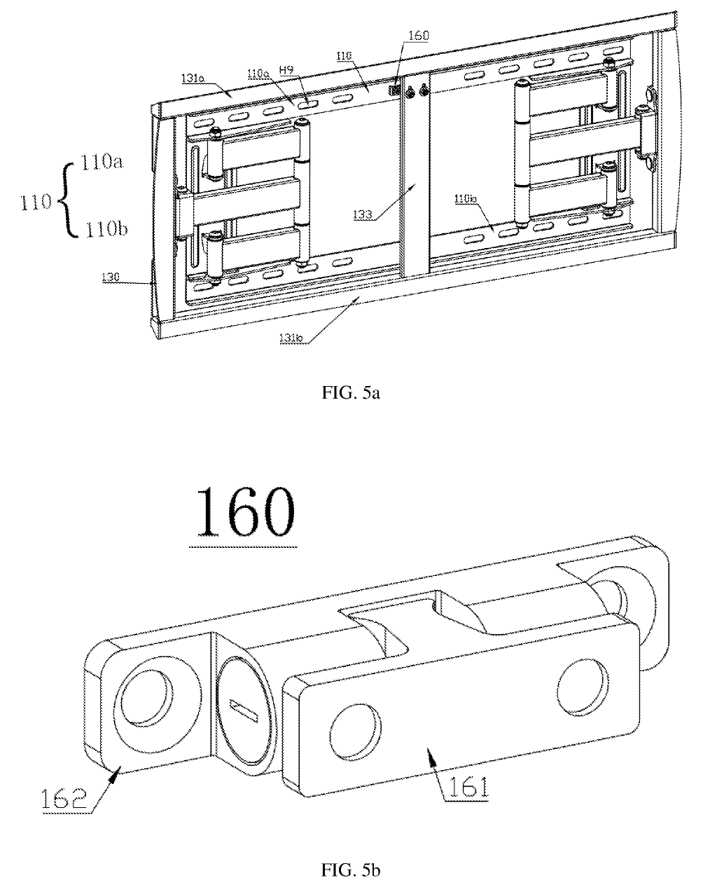

In at least one embodiment, please refer to FIGS. 5a and 5b. FIG. 5a is a structural view of the mounting bracket in a folded state as shown in FIG. 1a. FIG. 5b is a schematic structural view of the anti-rebound structure shown in FIG. 5a. The mounting bracket 100 can further include an anti-rebound structure 160. The anti-rebound structure 160 is connected between the panel structure 130 and the wall plate 110 when the mounting bracket 100 is folded.

The anti-rebound structure 160 can effectively prevent rebound of the panel structure 130. For example, when the user folds the mounting bracket 100, the mounting bracket 100 contracts. When the external force is removed, the panel structure 130 may tend to automatically return to its original shape or position due to inertia. The anti-rebound structure 160 can effectively suppress this rebound tendency of the panel structure 130, ensuring that the panel structure 130 remains in the desired position or shape, improving the overall stability and reliability of the mounting bracket 100. At the same time, the anti-rebound structure 160 helps maintain the stability of the mounting bracket 100 in the folded state, ensuring that the mounting bracket 100 remains stable after folding and preventing accidental unfolding due to external interference, extending the service life of the mounting bracket 100.

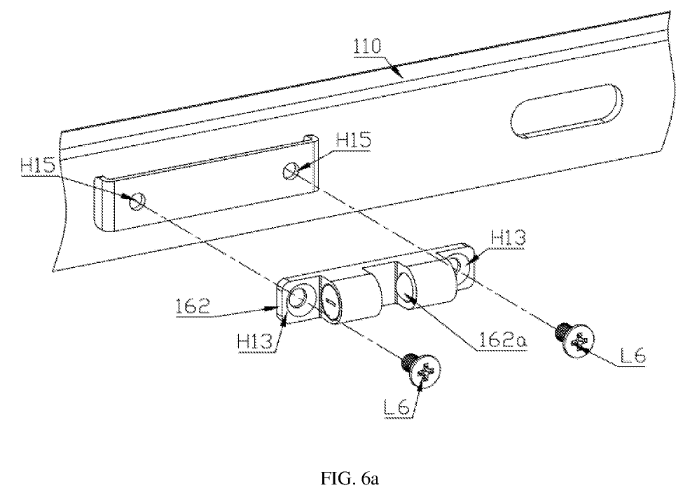

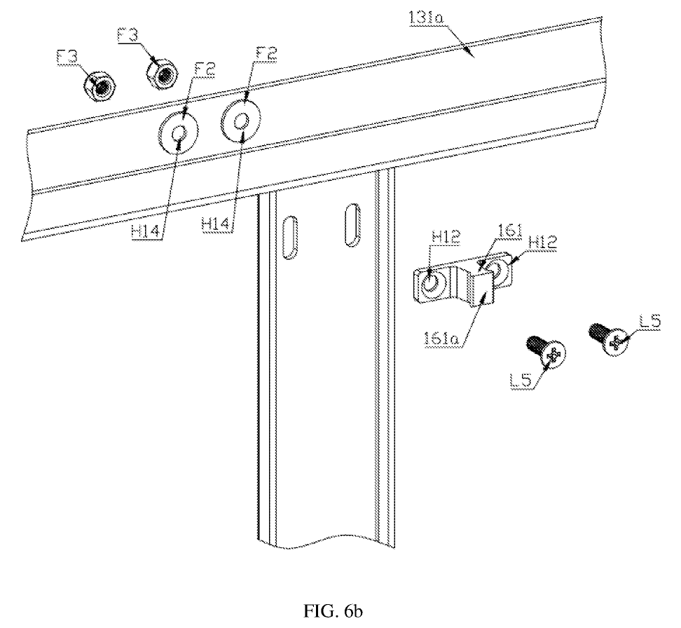

In at least one embodiment, please refer to FIGS. 6a and 6b. FIG. 6a is an exploded view of a ball plunger of the anti-rebound structure. FIG. 6b is an exploded view of a snap-fit member of the anti-rebound structure. The anti-rebound structure 160 may be a ball snap fastener assembly. The ball snap fastener assembly can include a snap-fit member 161 and a ball plunger member 162. The snap-fit member 161 is arranged on one side of the panel structure 130 facing the wall plate 110, and the ball plunger member 162 is arranged on one side of the wall plate 110 facing the panel structure 130. When the mounting bracket 100 is folded, the snap-fit member 161 approaches the ball plunger 162a, and the ball plunger 162a is pressed and embedded into a groove 161a of the snap-fit member 161. The panel structure 130 and the wall plate 110 are connected through the ball snap fastener assembly 163. When the mounting bracket 100 is unfolded, the ball plunger 162a is pressed and retracts from the groove 161a, separating the panel structure 130 from the wall plate 110.

Therefore, when folding the mounting bracket 100, simply bring the panel structure 130 close to the wall plate 110. The ball plunger 162a will be pressed when contacting the snap-fit member 161 and automatically embedded into the groove 161a, achieving folded locking of the mounting bracket 100. The operation is simple and quick. When unfolding the mounting bracket 100, simply apply a slight force to compress the ball plunger 162a out of the groove 161a, and the panel structure 130 and the wall plate 110 can separate, improving user operation efficiency and reducing time and effort costs.

Additionally, after the ball plunger 162a embeds into the groove 161a, a tight fit is formed, providing strong locking force and effectively preventing the mounting bracket 100 from accidentally rebounding due to external vibrations or collisions in the folded state.

The mounting process of the ball snap fastener assembly 163 is as follows: the snap-fit member 161 is defined with two ninth connection holes H12, and the upper horizontal arm 131a is correspondingly defined with two first mounting holes H14. Second connecting screw L5 passes through the ninth connection hole H12 of the snap-fit member 161 and the first mounting hole H14 on the upper horizontal arm 131a, respectively, and is fixed with second fixing component F3, achieving fixed connection between the snap-fit member 161 and the upper horizontal arm 131a. Two spacers F2 are provided at the connection between the snap-fit member 161 and the upper horizontal arm 131a. The ball plunger member 162 is defined with two tenth connection holes H13, and the side of the wall plate 110 facing the panel structure 130 is correspondingly defined with two second mounting holes H15. Third connecting screw L6 passes through the tenth connection hole H13 of the ball plunger member 162 and the second mounting hole H15 on the wall plate 110, respectively, achieving fixed connection between the ball plunger member 162 and the wall plate 110.

In at least one embodiment, the anti-rebound structure 160 may also include a magnetic structure. For example, opposite magnets are mounted on the side of the panel structure 130 facing the wall plate 110 and the side of the wall plate 110 facing the panel structure 130, respectively. When the mounting bracket 100 is contracted, the magnets attract each other, achieving the contraction function and preventing rebound. The structure of the anti-rebound structure 160 can be set according to actual conditions and is not specifically limited here.

In at least one embodiment, please continue to refer to FIGS. 5a. The panel structure 130 can include an extension plate 133 parallel to the connection side arm 132. The snap-fit member 161 is located on one side of the extension plate 133 facing the wall plate 110.

Therefore, the extension plate 133 provides additional mounting space for the snap-fit member 161. When other components on the panel structure 130 are densely arranged, the extension plate 133 can utilize the surrounding space of the panel structure 130 to ensure reasonable mounting positions for all components, maintaining the compact and orderly arrangement of the entire mounting bracket 100.

In at least one embodiment, one end of the extension plate 133 is fixedly connected to the upper horizontal arm 131a, and the other end of the extension plate 133 is fixedly connected to the lower horizontal arm 131b. The snap-fit member 161 is arranged on one side of one end of the extension plate 133 facing the wall plate 110.

One end of the extension plate 133 is fixedly connected to the upper horizontal arm 131a and the other end of the extension plate 133 is fixedly connected to the lower horizontal arm 131b, which makes the upper and lower parts of the panel structure 130 more tightly connected, enhancing the integrity of the entire panel structure 130. When the mounting bracket 100 bears the weight of the display device or is subjected to external impact, the extension plate 133 can effectively distribute stress, avoiding relative displacement or deformation between the upper horizontal arm 131a and lower horizontal arm 131b and improving the load-bearing capacity and anti-deformation ability of the mounting bracket 100.

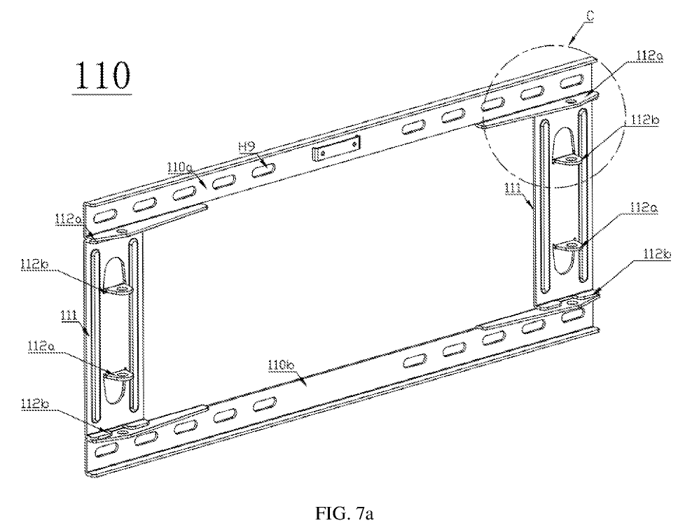

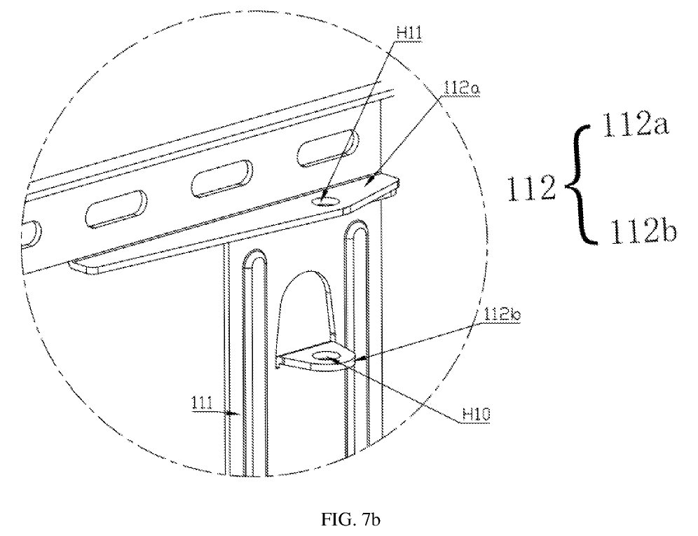

In at least one embodiment, please refer to FIGS. 7a and 7b. FIG. 7a is a structural view of the wall plate of the mounting bracket shown in FIG. 1a. FIG. 7b is an enlarged view of FIG. 7a taken along a circle C. The wall plate 110 can include an upper horizontal plate 110a and a lower horizontal plate 110b parallel to the upper horizontal plate 110a. The upper horizontal plate 110a and the lower horizontal plate 110b are each defined with a plurality of penetrating third elongated connection holes H9. The third elongated connection holes H9 on the upper horizontal plate 110a and the third elongated connection holes H9 on the lower horizontal plate 110b are correspondingly and arranged separately.

When the size and weight of the display device vary or the specific conditions of the mounting wall differ, the operator can change the mounting positions of the support arm 120 or hanging member 150 by selecting different third elongated connection holes H9 to achieve the best mounting effect. The spacing between the third elongated connection holes H9 is based on the standards of building structures and dimensions, allowing precise adaptation to the position and spacing of columns in the house. Thus, during mounting, nails can accurately hit the columns, providing stable support for the mounting bracket 100 and ensuring safe bearing of the weight of the display device, greatly improving the stability and reliability of the mounting of the mounting bracket 100.

In at least one embodiment, please continue to refer to FIGS. 7a and 7b. The wall plate 110 can further include at least one side plate 111 vertically connected between the upper horizontal plate 110a and the lower horizontal plate 110b. The wall plate 110 can further include at least one connecting assembly 112. One end of the rear support arm 121 is connected to the connecting assembly 112. The connecting assembly 112 can include an end connecting plate 112a and a positioning plate 112b. The end connecting plate 112a is arranged at a junction of the side plate 111 and the upper horizontal plate 110a or a junction of the side plate 111 and the lower horizontal plate 110b, and is in a shape of a long strip. The positioning plate 112b is arranged on the side plate 111 and perpendicular to the side plate 111, parallel and corresponding to the end connecting plate 112a. The positioning plate 112b is defined with a seventh connection hole H10, and the end connecting plate 112a is defined with an eighth connection hole H11. One end of the rear support arm 121 is located between the end connecting plate 112a and the positioning plate 112b and is connected via a third screw passing through the seventh connection hole H10, a through hole of the rear support arm 121 and the eighth connection hole H11.

Therefore, through the arrangement of the connecting assembly 112, during mounting of the mounting bracket 100, simply place one end of the rear support arm 121 accurately between the end connecting plate 112a and the positioning plate 112b, then use the third screw to pass through the corresponding seventh connection hole H10 and the corresponding eighth connection hole H11 for fixation, improving mounting efficiency. At the same time, the parallel and corresponding arrangement of the end connecting plate 112a and the positioning plate 112b, as well as the precise alignment of the seventh connection hole H10 and eighth connection hole H11 on them, ensure the accuracy of the mounting position of the rear support arm 121, guaranteeing the mounting of the panel structure 130 and the normal operation of the entire mounting bracket 100.

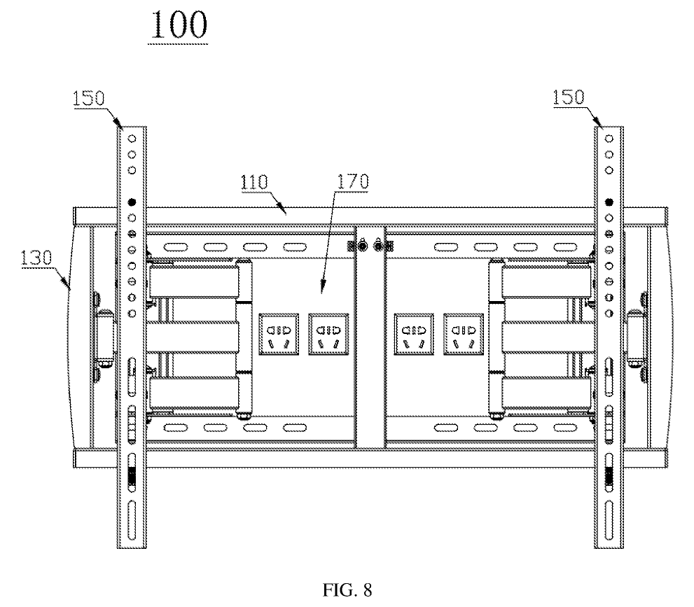

In at least one embodiment, please refer to FIG. 8. FIG. 8 is a front view of the mounting bracket in the folded state shown in FIG. 1a. A middle area of the wall plate 110 is defined with an avoidance structure 170. The avoidance structure 170 corresponds to and avoids the at least one socket. Therefore, by providing the avoidance structure 170, the mounting bracket 100 does not need to avoid the socket area during mounting, making full use of the wall space. There is no need to adjust the position of the mounting bracket 100 or make complex modifications to the wall to avoid sockets, greatly simplifying the mounting process, reducing mounting difficulty, and improving mounting efficiency.

Therefore, the mounting bracket 100 of the present disclosure adopts a single-wall-plate dual-support-arm bilateral symmetrical structure, which can evenly distribute the weight of the display device and various external forces encountered during use, effectively avoiding structural tilting or deformation caused by unilateral force, greatly ensuring overall structural stability, and significantly enhancing load-bearing capacity.

Additionally, the mounting bracket 100 of the present disclosure can achieve at least the following four-dimensional adjustments in terms of angle adjustment:

First, in the Y-axis direction (i.e., the thickness direction), the mounting bracket 100 enables telescopic adjustment: The front support arm 122 is pivotally connected to the connecting piece 140, with its pivot axis extending vertically, allowing the front support arm 122 to perform front-to-back telescopic movement along the Y-axis direction. When adjusting the distance between the display device and the wall, the coordinated operation of relevant components enables the front support arm 122 to move flexibly along the Y-axis direction, driving the display device closer to or farther from the wall, thereby providing users with a more optimal viewing distance.

Second, the mounting bracket 100 allows pitch angle adjustment (i.e., rotation about the X-axis): the front support arm 122 is pivotally connected to the connecting piece 140, and the connecting piece 140 is connected to the panel structure 130 via the connection members 141. The panel structure 130 is defined with a first elongated connecting hole H1 and a first connecting hole H2. When the connection members 141 are loosened, the movement allowance provided by the first elongated connecting hole H1 allows manual application of external force to adjust the connection position between the connecting piece 140 and the panel structure 130, causing the panel structure 130 to rotate about the X-axis. This enables pitch angle adjustment of the display device, allowing users to achieve a more comfortable viewing experience.

Third, the mounting bracket 100 can change the orientation of the display surface of the display device: The rear support arm 121 is hinged to the wall plate 110, and the front support arm 122 is similarly hinged to the rear support arm 121, with both hinge points having vertically extending pivot axes. This allows the rear support arm 121 to rotate left and right about the vertical pivot axis, thereby driving the front support arm 122 connected to the rear support arm 121 and display device to change their orientation in the horizontal plane.

Fourth, the mounting bracket 100 enables adjustment of the horizontal tilt angle of the display device: The hanging strip 151 and hanging hook 152 have freedom of movement in the height direction. By rotating the adjusting screw L1 and utilizing the threaded connection between the adjusting screw L1 and the hanging strip 151, the hanging strip 151 can be precisely adjusted relative to the hanging hook 152 in the height direction. During installation, factors such as wall flatness and mounting accuracy of the wall plate 110 may cause the display device to deviate from perfect leveling. In such cases, operators can operate the adjusting screws L1 on either or both hanging members 150 to correct the tilt. For example, if the left side of the display device is too high, the installer can operate the adjusting screw L1 on the left hanging member 150 to lower the hanging strip 151, reducing the left-side height. Alternatively, the adjusting screw L1 on the right hanging member 150 can be operated to raise the hanging strip 151, increasing the right-side height. Conversely, if the right side is too high, the adjusting screw L1 on the right hanging member 150 can be adjusted to lower the right-side height, quickly correcting the horizontal tilt angle. Similarly, the adjusting screw L1 on the left hanging member 150 can be adjusted to raise the left-side height. This ensures the display device remains level, optimizing viewing quality.

In the above embodiments, each description emphasizes different aspects. For parts not detailed in a particular embodiment, reference may be made to related descriptions in other embodiments. The detailed explanation of the embodiments of the present disclosure aims to clarify its principles and implementation methods through specific examples. The descriptions are intended to facilitate understanding of the method and core concepts of the present disclosure. Meanwhile, those of ordinary skill in the art may make modifications to specific implementations and applications based on the ideas presented herein. Therefore, the content of the present disclosure should not be construed as limiting the scope of the present disclosure. Any modifications, equivalent substitutions, or improvements made within the spirit and principles of the above embodiments shall fall within the protection scope of the technical solution.

What is claimed is:

1. A mounting bracket, comprising:
a wall plate;
at least one hanging member, the at least one hanging member being configured for fixed connection with a display device; and
a movable assembly comprising:
at least one support arm, wherein one end of the at least one support arm is pivotally connected to the wall plate;
a panel structure, wherein: the panel structure comprises an upper horizontal arm and a lower horizontal arm parallel to the upper horizontal arm, as well as at least one connection side arm vertically connected between the upper horizontal arm and the lower horizontal arm; each hanging member is connected to the upper horizontal arm and locked to the lower horizontal arm; a plane of the connection side arms is perpendicular to an extending direction of the upper horizontal arm and the lower horizontal arm; the connection side arm defines a first elongated connection hole and a first connection hole penetrating through the connection side arm; and the first elongated connection hole is horizontally arranged and located above the first connection hole; and
at least one connection piece and at least one pair of connection members; wherein: the connection piece is arranged at the connection side arm; one side of the connection piece is pivotally connected to the other end of the support arm, and the other side of the connection piece is connected to the first elongated connection hole and the first connection hole via the pair of the connection members; and when the connection piece is fixed at different positions in the first elongated connection hole, the panel structure has different pitch angles relative to the wall plate.

2. The mounting bracket according to claim 1, wherein the first elongated connection hole is an arc-shaped hole centered on the first connection hole.

3. The mounting bracket according to claim 1, wherein the connection piece comprises:
a main body portion, wherein: the main body portion is a long strip-shaped plate structure, the main body portion defines two second connection holes penetrated through the main body portion; and the two second connection holes correspond to the first elongated connection hole and the first connection hole on the connection side arm, respectively; and
a U-shaped connection portion, wherein the U-shaped connection portion is vertically arranged on one side of the main body portion away from the connection side arm, an opening of the U-shaped connection portion faces the wall plate;
wherein the U-shaped connection portion is located between the two second connection holes on the main body portion.

4. The mounting bracket according to claim 3, wherein: the two second connection holes on the main body portion are non-circular holes, and each of the at least one pair of connection members comprises a matching non-circular segment; and when the connection member passes through the non-circular hole, the non-circular hole and the non-circular segment of the connection member fit together, restricting a rotation of the connection member relative to the connection piece and forming an anti-rotation structure.

5. The mounting bracket according to claim 3, wherein: the support arm comprises a rear support arm and a front support arm; and one end of the rear support arm is hinged to the wall plate, one end of the front support arm is hinged to the other end of the rear support arm, and the other end of the front support arm is pivotally connected to the connection piece.

6. The mounting bracket according to claim 5, wherein: two opposite side arms of the U-shaped connection portion are horizontally arranged and each of the two side arms is defined with a third connection hole penetrating therethrough along a height direction of the mounting bracket; the front support arm is embedded in the U-shaped connection portion; and a first screw passes through the third connection hole to pivotally connect the front support arm and the U-shaped connection portion.

7. The mounting bracket according to claim 6, wherein: the at least one support arm are two support arms, the at least one connection piece are two connection pieces, the at least one connection side arm are two connection side arms; the two connection side arms are located on opposite sides of the panel structure;
one of the two support arms, one of the two connection pieces, and one of the two connection side arms correspond with each other; and
the front support arms of the two support arms are respectively embedded in the U-shaped connection portions of the two connection pieces and pivotally connected; the main body portions of the two connection pieces are respectively connected to the two connection side arms.

8. The mounting bracket according to claim 1, wherein: the hanging member comprises a hanging strip and a hanging hook; the hanging strip and the hanging hook are connected and have a freedom of movement in a height direction of the mounting bracket; the hanging hook is hung on the upper horizontal arm of the panel structure; and the hanging member further comprises an adjusting screw, and the adjusting screw is threaded into the hanging strip and abuts against the upper horizontal arm.

9. The mounting bracket according to claim 8, wherein: the hanging strip comprises a movable plate and two movable side plates respectively connected to two opposite sides of the movable plate; the movable plate and the two movable side plates cooperatively form a clamping space; the hanging hook comprises a connecting plate and two connecting side plates respectively connected to two opposite sides of the connecting plate; a size of the hanging hook is smaller than that of the hanging strip and is accommodated in the clamping space of the hanging strip; the movable side plate is defined with a plurality of fourth connection holes penetrating through the movable side plate; the connecting side plate is defined with a plurality of second elongated connection holes extending in the height direction and corresponding to the plurality of fourth connection holes on the movable side plate respectively; and when the adjusting screw is rotated, the hanging strip moves relative to the hanging hook in the height direction via the second elongated connection holes, causing the panel structure to have different tilt angles in the horizontal direction.

10. The mounting bracket according to claim 8, wherein: one end of the hanging strip comprises a first fixing plate perpendicular to the hanging strip; the first fixing plate is defined with a fifth connection hole penetrated through the first fixing plate; and the adjusting screw passes through the fifth connection hole of the first fixing plate and abuts against the upper horizontal arm.

11. The mounting bracket according to claim 8, wherein: one end of the hook comprises a second fixing plate perpendicular to the hanging hook; the second fixing plate is defined with a sixth connection hole penetrated through the second fixing plate; the mounting bracket furthers comprise a second screw; and the second screw is threaded into the sixth connection hole and abuts against the lower horizontal arm.

12. The mounting bracket according to claim 1, wherein the mounting bracket further comprises an anti-rebound structure, the anti-rebound structure is connected between the panel structure and the wall plate when the mounting bracket is folded.

13. The mounting bracket according to claim 12, wherein: the anti-rebound structure is a ball snap fastener assembly; the ball snap fastener assembly comprises a snap-fit member and a ball plunger; the snap-fit member is arranged on one side of the panel structure facing the wall plate, and the ball plunger is arranged on one side of the wall plate facing the panel structure; when the mounting bracket is folded, the snap-fit member approaches the ball plunger, the ball plunger is pressed and embedded into a groove of the snap-fit member, connecting the panel structure and the wall plate; and when the mounting bracket is unfolded, the ball plunger is pressed and retracts from the groove, separating the panel structure and the wall plate.

14. The mounting bracket according to claim 13, wherein: the panel structure comprises an extension plate parallel to the connection side arm; and the snap-fit member is arranged on one side of the extension plate facing the wall plate.

15. The mounting bracket according to claim 14, wherein: one end of the extension plate is fixedly connected to the upper horizontal arm, and the other end of the extension plate is fixedly connected to the lower horizontal arm; and the snap-fit member is arranged on one side of one end of the extension plate facing the wall plate.

16. The mounting bracket according to claim 5, wherein: the wall plate comprises an upper horizontal plate and a lower horizontal plate parallel to the upper horizontal plate; and both the upper horizontal plate and the lower horizontal plate define a plurality of penetrating third elongated connection holes, the third elongated connection holes on the upper horizontal plate and the third elongated connection holes on the lower horizontal plate are correspondingly and arranged separately.

17. The mounting bracket according to claim 16, wherein: the wall plate further comprises at least one side plate vertically connected between the upper horizontal plate and the lower horizontal plate, as well as at least one connecting assembly; one end of the rear support arm is connected to the connecting assembly; the connecting assembly comprises an end connecting plate and a positioning plate; the end connecting plate is arranged at a junction of the side plate and the upper horizontal plate or a junction of the side plate and the lower horizontal plate, and is in a shape of a long strip; the positioning plate is arranged on the side plate and perpendicular to the side plate; the positioning plate is parallel and corresponding to the end connecting plate; the positioning plate is defined with a seventh connection hole, and the end connecting plate is defined with an eighth connection hole; and one end of the rear support arm is located between the end connecting plate and the positioning plate and is connected via a third screw.

18. The mounting bracket according to claim 1, wherein a middle area of the wall plate is defined with an avoidance structure.
